(19) United States
(12) Patent Application Publication
(10) Pub. No.: US 2016/0020464 A1
(43) Pub. Date: Jan. 21, 2016

(54) LITHIUM MANGANESE BORATE-BASED CATHODE ACTIVE MATERIAL, LITHIUM ION SECONDARY BATTERY INCLUDING THE SAME AND METHOD FOR PREPARING THE SAME

(71) Applicant: KOREA INSTITUTE OF SCIENCE AND TECHNOLOGY, Seoul (KR)

(72) Inventors: Kyung Yoon CHUNG, Seoul (KR); Ji Ung KIM, Seoul (KR); Haein JO, Seoul (KR); Ji-Young KIM, Seoul (KR); Si Hyoung OH, Seoul (KR); Won Chang CHOI, Seoul (KR); Hwa Young LEE, Seoul (KR); Byung Won CHO, Seoul (KR)

(21) Appl. No.: 14/528,609

(22) Filed: Oct. 30, 2014

(30) Foreign Application Priority Data
Jul. 18, 2014 (KR) 10-2014-0090896

(51) Int. Cl. H01M 4/58; H01M 4/136

(52) U.S. Cl. CPC H01M 4/5825; H01M 4/136; H01M 2004/028

(57) ABSTRACT

Disclosed is a lithium manganese borate-based cathode active material. The cathode active material can be used to fabricate a lithium ion secondary battery that has advantages, such as high output capacity and cycle capacity, in comparison with lithium ion secondary batteries using conventional cathode active materials. Also disclosed are a lithium ion secondary battery including the cathode active material and a method for preparing the cathode active material.

### CROSS-REFERENCE TO RELATED APPLICATIONS

This application claims priority under 35 U.S.C. §119 to Korean Patent Application No. 10-2014-0090896 filed on Jul. 18, 2014 in the Korean Intellectual Property Office, the disclosure of which is incorporated herein by reference in its entirety.

### BACKGROUND OF THE INVENTION

1. Field of the Invention

The present invention relates to a lithium manganese borate-based cathode active material, a lithium ion secondary battery including the cathode active material, and a method for preparing the cathode active material.

2. Description of the Related Art

Olivine-type phosphate compounds LiMPO₄ (M=Fe, Mn, Co . . . ) have recently been used as electrode active materials and are known to undergo less reduction in capacity even after a number of charge-discharge cycles due to their high stability. However, the theoretical capacities of the olivine-type phosphate compounds are not sufficiently high to meet applications where high capacity secondary batteries are needed.

Lithium borate materials LiMBO₃ (M=Fe, Mn, Co . . . ) have been proposed as alternatives to olivine-type phosphate compounds. Such borate materials possessing the lightest triangle oxyanion (BO₃)³⁻ have received great attention as replacements for lithium phosphates consisting of (PO₄)³⁻. For this reason, it is known that the borate materials have higher theoretical capacities (ca. 220 mAh/g) than phosphate materials. In addition, the borate materials are known to have high volumetric energy densities because they have similar densities to lithium phosphate.

According to previous reports, borate materials are susceptible to the occurrence of structural resistance, and as a result, their high theoretical capacities are not sufficiently available and output capacities as low as 80 mAh/g are exhibited.

Generally, manganese (Mn) in LiMnBO₃ has a higher oxidation-reduction potential than iron (Fe). Due to this advantage, manganese-containing compounds have been proposed as potential candidates for cathode materials. LiMnBO₃ containing Mn is theoretically known as a cathode material that has a higher operating voltage than LiFeBO₃ containing Fe, but suffers from the limitation of lower capacity than LiFeBO₃ because of its low electrical conductivity and ionic conductivity, which are inherent to Mn-based borate materials.

### PRIOR ART DOCUMENTS

### Patent Document

Korean Patent Publication No. 10-2011-0118806

### Non-Patent Documents

Legagneur et. al., Solid State Ionics, 139, pp 37-46 (2001)
Jae Chul Kim, Journal of The Electrochemical Society, 158 (3), A309-A315 (2011)
Atsuo Yamada, Journal of Materials Chemistry, 21, 10690-10696 (2011)

### SUMMARY OF THE INVENTION

The present invention has been made in an effort to solve the problems of poor performance characteristics (for example, low theoretical capacity) encountered with conventional cathode active materials, and it is an object of the present invention to provide a lithium manganese borate-based cathode active material, a lithium ion secondary battery including the cathode active material, and a method for preparing the cathode active material.

One aspect of the present invention relates to a cathode active material of Formula 1:

LiₓMn(BO₃)_{y} (1)

wherein x is a real number satisfying 1≦x<2, y is a real number satisfying 1≦y<2, with the proviso that x and y are not simultaneously 1.

A further aspect of the present invention relates to a working electrode for a lithium ion battery including a cathode active material according to exemplary embodiments of the present invention.

Another aspect of the present invention relates to a lithium ion battery including a cathode active material according to exemplary embodiments of the present invention.

Yet another aspect of the present invention relates to a method for preparing a cathode active material according to exemplary embodiments of the present invention, the method including (A) ball milling a mixture of a lithium precursor, a manganese precursor, a boron precursor, and a carbon compound, (B) annealing the ball-milled mixture, and (C) lowering the temperature of the annealed mixture.

According to exemplary embodiments of the present invention, the lithium manganese borate-based cathode active material can be used to fabricate a lithium ion secondary battery that has advantages, such as high output capacity and cycle capacity, in comparison with lithium ion secondary batteries using conventional cathode active materials.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 shows the results of x-ray diffraction analysis for lithium manganese borate compounds according to embodiments of the present invention;

FIG. 2 shows charge-discharge curves of lithium ion secondary batteries including lithium manganese borate compounds according to embodiments of the present invention; and

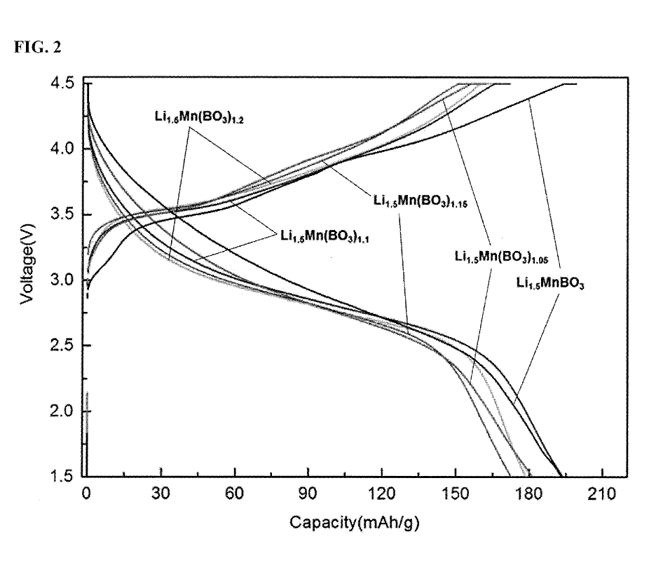

FIG. 3 shows the results of x-ray diffraction analysis for lithium manganese borate compounds according to embodiments of the present invention.

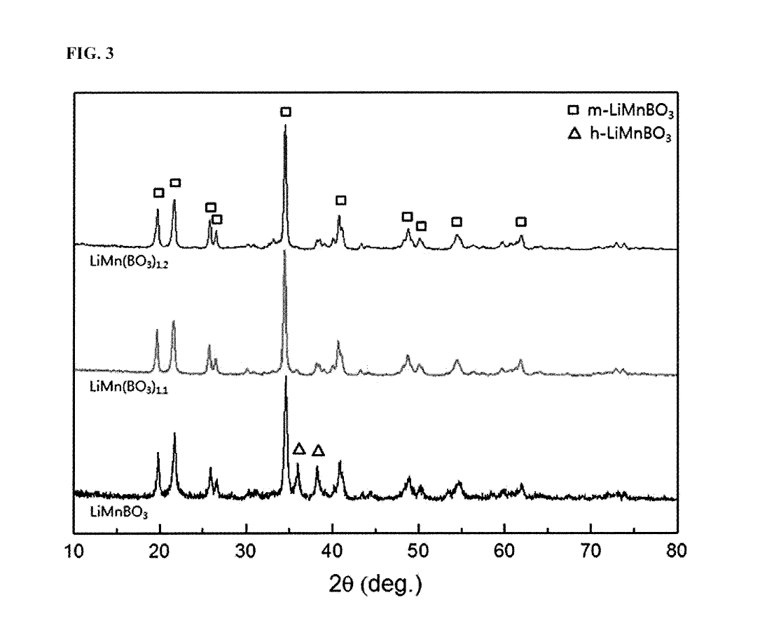

### DETAILED DESCRIPTION OF THE INVENTION

Several aspects and embodiments of the present invention will now be described in more detail.

One aspect of the present invention relates to a cathode active material of Formula 1:

LiₓMn(BO₃)_{y} (1)

wherein x is a real number satisfying 1≦x<2, y is a real number satisfying 1≦y<2, with the proviso that x and y are not simultaneously 1.

According to one embodiment, x is a real number satisfying 1<x<2 and y is a real number satisfying 1<y<2.

The cathode active material wherein x and y satisfy 1<x<2 and 1<y<2, respectively, has a significantly high proportion of pure monoclinic phase and can be used to fabricate a lithium ion secondary battery with markedly improved cycle capacity, compared to the cathode active material wherein x is 1 and y satisfies 1<y<2 as well as the cathode active material wherein x is 1 and y is 1 and the cathode active material wherein x satisfies 1<x<2 and y is 1.

According to a further embodiment, y is a real number satisfying 1.1≦y<2, particularly when x satisfies 1<x<2.

The results of XRD analysis show that the cathode active material wherein x satisfies 1<x<2 and particularly y satisfies 1.1≦y<2 has greatly reduced intensities of a second effective peak observed in the range of 2θ=40° to 430 and a third effective peak observed in the range of 2θ=57° to 600 based on the intensity of a first effective peak observed in the range of 2θ=33° to 360, compared to the cathode active material wherein x satisfies 1<x<2 and y satisfies 1<y<1.1. These results are attributed to a dramatic rise in the proportion of pure monoclinic phase resulting from a drastically reduced content of MnO as an impurity. Although specific experimental results are not presented diagrammatically herein, the use of the cathode active material wherein y is greater than or equal to 1.1 markedly improves the charge-discharge performance of a lithium ion secondary battery after at least 10 charge-discharge cycles.

According to another embodiment, XRD analysis of the cathode active material wherein x satisfies 1<x<2 shows that when the intensity of a first effective peak observed in the range of 2θ=33° to 360 is defined as 1, the intensity of a second effective peak observed in the range of 2θ=40° to 430 is from 0.1 to 0.5 and the intensity of a third effective peak observed in the range of 2θ=57° to 600 is from 0.0001 to 0.1.

Specifically, when the intensity of the first effective peak is defined as 1, the intensity of the second effective peak may be in the range of 0.1 to 0.9, 0.1 to 0.7, 0.1 to 0.5, or 0.1 to 0.4. When the intensity of the first effective peak is defined as 1, the intensity of the third effective peak may be in the range of 0.0001 to 0.3, 0.0001 to 0.2, 0.0001 to 0.1, or 0.0001 to 0.05.

According to another embodiment, particularly, the proportion of monoclinic phase in the cathode active material wherein x satisfies 1<x<2 is from 90% to 100%, based on the total proportion of monoclinic phase, hexagonal phase, and MnO phases.

That is, the proportion of monoclinic phase in the cathode active material wherein x and y satisfy 1<x<2 and 1<y<2, respectively, may be from 90% to 100%, based on the total proportion of monoclinic and hexagonal phases. Particularly, when the proportion of monoclinic phase exceeds 95%, the proportion of MnO acting as an impurity is considerably lowered, resulting in a marked improvement in cycle performance.

According to one embodiment, y is a real number satisfying 1<y<2, particularly when x is 1.

The cathode active material wherein x is 1 and y satisfies 1<y<2 has a significantly high proportion of pure monoclinic phase and can be used to fabricate a lithium ion secondary battery with markedly improved cycle capacity, compared to the cathode active material wherein x is 1 and y satisfies 1<x<2 as well as the cathode active material wherein both x and y are 1.

The results of XRD analysis show that the cathode active material wherein x is 1 and y satisfies 1<x<2 has greatly reduced intensities of second and third effective peaks observed in the range of 2θ=35° to 400, based on the intensity of a first effective peak observed in the range of 2θ=33° to 36°, compared to the cathode active material wherein both x and y are 1. These results are attributed to a dramatic rise in the proportion of pure monoclinic phase.

According to a further embodiment, particularly, XRD analysis of the cathode active material wherein x is 1 shows that when the intensity of a first effective peak observed in the range of 2θ=33° to 36° is defined as 1, each of the intensities of second and third effective peaks observed in the range of 2θ=35° to 40° is from 0.00001 to 0.1.

Specifically, when the intensity of the first effective peak is defined as 1, each of the intensities of the second and third effective peaks may be in the range of 0 to 0.2, 0.0001 to 0.15, 0.0001 to 0.1, 0.0001 to 0.05, or 0.0001 to 0.01.

According to another embodiment, particularly, x may be 1. In this embodiment, the proportion of monoclinic phase in the cathode active material is from 90% to 100%, based on the total proportion of monoclinic and hexagonal phases.

That is, the proportion of monoclinic phase in the cathode active material wherein x is 1 and y satisfies 1<x<2 may be from 90% to 100%, based on the total proportion of monoclinic and hexagonal phases. Particularly, when the proportion of monoclinic phase exceeds 95%, the discharge capacity and cycle performance of a lithium ion secondary battery using the cathode active material are slightly improved.

A further aspect of the present invention relates to a working electrode for a lithium ion battery including the cathode active material according to any one of the exemplary embodiments.

Another aspect of the present invention relates to a lithium ion battery including the cathode active material according to any one of the exemplary embodiments.

Yet another aspect of the present invention relates to a method for preparing the cathode active material according to any one of the exemplary embodiments, the method including (A) ball milling a mixture of a lithium precursor, a manganese precursor, a boron precursor, and a carbon compound, (B) annealing the ball-milled mixture, and (C) lowering the temperature of the annealed mixture.

According to one embodiment, the lithium precursor is selected from Li₂CO₃, LiOH.H₂O, LiNO₃, LiBO₂, and mixtures thereof. The manganese precursor is selected from MnC₂O₄.2H₂O, MnNO₃.(H₂O)₄, MnCO₃, MnO₂, and mixtures thereof. The boron precursor is selected from B₂O₃, B(OC₂H₅)₄, H₃BO₃, and mixtures thereof. The carbon compound is selected from C₁₂H₂₂O₁₁, C₆H₁₀O₄, C₈H₈O₇, and mixtures thereof.

According to a further embodiment, the carbon compound is included in an amount of 5 to 15% by weight, based on the total weight of the mixture.

According to another embodiment, in step (A), the ball milling is performed by a dry process in which the precursors and the carbon compound are mixed and ground at a rate of 150 to 350 rpm using beads in an amount of 10 to 30 times the total weight of the mixture.

According to another embodiment, step (B) is carried out by heating the ball-milled mixture to 400 to 800° C. at a rate of 1 to 5° C./min and heating for 10 to 20 hours to maintain the temperature.

According to another embodiment, step (C) is carried out by lowering the temperature of the annealed mixture to room temperature at a rate of 1 to 5° C./min.

According to another embodiment, the cooling rate is from 0.8- to 1.2-fold, preferably from 0.9- to 1.1-fold, most preferably 1-fold, compared to the heating rate.

The present invention will be explained in more detail with reference to the following examples. However, these examples are not to be construed as limiting or restricting the scope and disclosure of the invention. It is to be understood that based on the teachings of the present invention including the following examples, those skilled in the art can readily practice other embodiments of the present invention whose experimental results are not explicitly presented.

### EXAMPLES

### Example 1-1

### Preparation of Li_{1.5}MnBO₃)_{1.2}

MnC₂O₄.2H₂O as a divalent manganese compound, diboron trioxide (B₂O₃), and lithium carbonate (Li₂CO₃) in a molar ratio of 1:1.2:1.5 were placed in a planetary ball mill, and sucrose (C₁₂H₂₂O₁₁) was added thereto to improve the conductivity of the active material. The sucrose was used in an amount of 10 wt %, based on the weight of the final material. To the planetary ball mill were added beads in an amount of 20 times the total weight of the mixture. Then, the mixture was mixed and ground at 250 rpm for 6 h. After the ball milling, the mixture was heated to 600° C. at a rate of 2° C./min, annealed for 15 h, and cooled to room temperature at the same rate as the heating rate, yielding Li_{1.5}Mn(BO₃)_{1.2}.

### Example 1-2

### Preparation of Li_{1.5}Mn(BO₃)_{1.15}

Li_{1.5}Mn(BO₃)_{1.15} was prepared in the same manner as in Example 1-1, except that the molar ratio of MnC₂O₄.2H₂O as a divalent manganese compound, diboron trioxide (B₂O₃), and lithium carbonate (Li₂CO₃) was changed from 1:1.2:1.5 to 1:1.15:1.5.

### Example 1-3

### Preparation of Li_{1.5}Mn(BO₃)_{1.1}

Li_{1.5}Mn(BO₃)_{1.1} was prepared in the same manner as in Example 1-1, except that the molar ratio of MnC₂O₄.2H₂O as a divalent manganese compound, diboron trioxide (B₂O₃), and lithium carbonate (Li₂CO₃) was changed from 1:1.2:1.5 to 1:1.1:1.5.

### Example 1-4

### Preparation of Li_{1.5}Mn(BO₃)_{1.05}

Li_{1.5}Mn(BO₃)_{1.05} was prepared in the same manner as in Example 1-1, except that the molar ratio of MnC₂O₄.2H₂O as a divalent manganese compound, diboron trioxide (B₂O₃), and lithium carbonate (Li₂CO₃) was changed from 1:1.2:1.5 to 1:1.05:1.5.

### Comparative Example 1

### Preparation of Li_{1.5}MnBO₃

Li_{1.5}MnBO₃ was prepared in the same manner as in Example 1-1, except that the molar ratio of MnC₂O₄.2H₂O as a divalent manganese compound, diboron trioxide (B₂O₃), and lithium carbonate (Li₂CO₃) was changed from 1:1.2:1.5 to 1:1:1.5.

### Example 2-1

### Preparation of Li_{1.0}Mn(BO₃)_{1.2}

Li_{1.0}Mn(BO₃)_{1.2} was prepared in the same manner as in Example 1-1, except that the molar ratio of MnC₂O₄.2H₂O as a divalent manganese compound, diboron trioxide (B₂O₃), and lithium carbonate (Li₂CO₃) was changed from 1:1.2:1.5 to 1:1.2:1.

### Example 2-2

### Preparation of Li_{1.0}Mn(BO₃)_{1.1}

Li_{1.0}Mn(BO₃)_{1.1} was prepared in the same manner as in Example 1-1, except that the molar ratio of MnC₂O₄.2H₂O as a divalent manganese compound, diboron trioxide (B₂O₃), and lithium carbonate (Li₂CO₃) was changed from 1:1.2:1.5 to 1:1.1:1.

### Comparative Example 2

### Preparation of Li_{1.0}MnBO₃

Li_{1.0}MnBO₃ was prepared in the same manner as in Example 1-1, except that the molar ratio of MnC₂O₄.2H₂O as a divalent manganese compound, diboron trioxide (B₂O₃), and lithium carbonate (Li₂CO₃) was changed from 1:1.2:1.5 to 1:1:1.

### Example 3-1

### Fabrication of Lithium Ion Secondary Battery

0.5 g of the lithium manganese borate-based cathode active material prepared in Example 1-1, 0.0625 g of Denka Black, and 5% PVDF were dissolved in 1.25 g of NMP. To the solution was added NMP to prepare a slurry. The slurry was cast on a thin aluminum plate and dried in a vacuum oven at 120° C. for 6 h to produce an electrode. The electrode, a PP separator, and lithium as an anode material were used to fabricate a coin-type lithium ion secondary battery.

A 1 M solution of a LiPF₆ salt in a mixture of ethylene carbonate and dimethyl carbonate in a volume ratio of 1:1 was used as an electrolyte.

The capacities of the coin-type battery were measured during charge and discharge in the voltage range of 1.5-4.5 V, and changes in the capacity of the coin-type battery at various C rates were measured.

### Example 3-2

### Fabrication of Lithium Ion Secondary Battery

A coin-type lithium ion secondary battery was fabricated in the same manner as in Example 3-1, except that the Li_{1.5}Mn(BO₃)_{1.15} compound prepared in Example 1-2 was used as a cathode active material instead of the Li_{1.5}Mn(BO₃)_{1.2} compound prepared in Example 1-1.

### Example 3-3

### Fabrication of Lithium Ion Secondary Battery

A coin-type lithium ion secondary battery was fabricated in the same manner as in Example 3-1, except that the Li_{1.5}Mn(BO₃)_{1.1} compound prepared in Example 1-3 was used as a cathode active material instead of the Li_{1.5}Mn(BO₃)_{1.2} compound prepared in Example 1-1.

### Example 3-4

### Fabrication of Lithium Ion Secondary Battery

A coin-type lithium ion secondary battery was fabricated in the same manner as in Example 3-1, except that the Li_{1.5}Mn(BO₃)_{1.05} compound prepared in Example 1-4 was used as a cathode active material instead of the Li_{1.5}Mn(BO₃)_{1.2} compound prepared in Example 1-1.

### Comparative Example 3

### Fabrication of Lithium Ion Secondary Battery

A coin-type lithium ion secondary battery was fabricated in the same manner as in Example 3-1, except that the Li_{1.5}MnBO₃ compound prepared in Comparative Example 1 was used as a cathode active material instead of the Li_{1.5}Mn(BO₃)_{1.2} compound prepared in Example 1-1.

### Example 4-1

### Fabrication of Lithium Ion Secondary Battery

A coin-type lithium ion secondary battery was fabricated in the same manner as in Example 3-1, except that the Li_{1.0}Mn(BO₃)_{1.2} compound prepared in Example 2-1 was used as a cathode active material instead of the Li_{1.5}Mn(BO₃)_{1.2} compound prepared in Example 1-1.

### Example 4-2

### Fabrication of Lithium Ion Secondary Battery

A coin-type lithium ion secondary battery was fabricated in the same manner as in Example 3-1, except that the Li_{1.0}Mn(BO₃)_{1.1} compound prepared in Example 2-2 was used as a cathode active material instead of the Li_{1.5}Mn(BO₃)_{1.2} compound prepared in Example 1-1.

### Comparative Example 4

### Fabrication of Lithium Ion Secondary Battery

A coin-type lithium ion secondary battery was fabricated in the same manner as in Example 3-1, except that the Li_{1.0}MnBO₃ compound prepared in Comparative Example 2 was used as a cathode active material instead of the Li_{1.5}Mn(BO₃)_{1.2} compound prepared in Example 1-1.

### Test Example 1

### X-Ray Diffraction Analysis

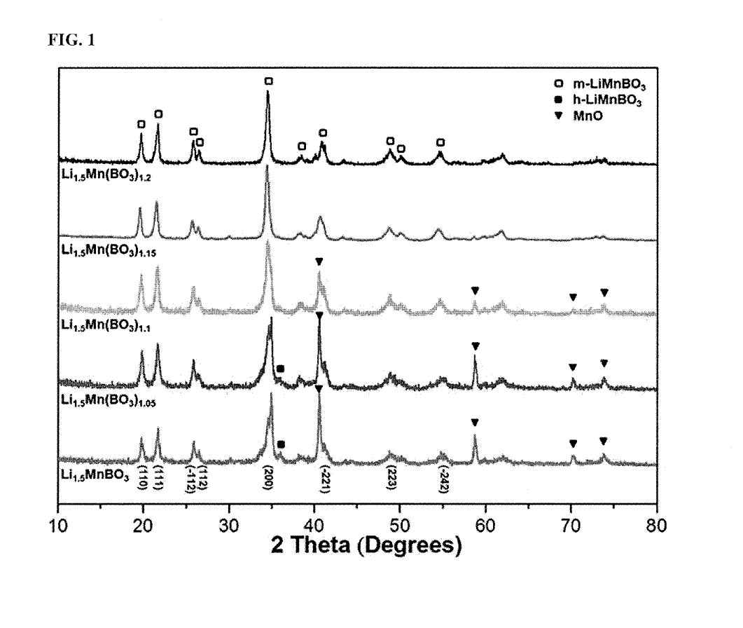

X-ray diffraction analysis was conducted on the cathode active materials prepared in Examples 1-1 to 1-4 and Comparative Example 1, and the results are shown in FIG. 1. As can be seen from FIG. 1, the cathode active material of Comparative Example 1 contained manganese oxide as an impurity formed by addition of the excess lithium.

A considerable amount of manganese oxide was still present in the cathode active material of Example 1-4. In contrast, the amount of manganese oxide in the cathode active material of Example 1-3 was substantially negligible, and no peaks corresponding to manganese oxide were observed in the x-ray diffraction patterns of the cathode active materials prepared in Examples 1-1 and 1-2.

### Test Example 2

### Output Capacity Measurement

Charge/discharge tests were conducted on the lithium ion secondary batteries fabricated in Examples 3-1 to 3-4 and Comparative Example 3. The output capacities of the lithium ion secondary batteries were measured after 1 and 10 charge/discharge cycles. As a result, the initial output capacities of the lithium ion secondary batteries of Examples 3-1 to 3-4 were found to be higher by 4.1%, 4.6%, 5.2%, and 5.4%, respectively, than the initial output capacity of the lithium ion secondary battery of Comparative Example 3. The output capacities of the lithium ion secondary batteries of Examples 3-2 to 3-4 after 10 cycles were found to be higher by approximately 30% than those of the lithium ion secondary battery of Example 3-1 as well as the lithium ion secondary battery of Comparative Example 3.

### Test Example 3

### X-Ray Diffraction Analysis

X-ray diffraction analysis was conducted on the cathode active materials prepared in Examples 2-1 and 2-2 and Comparative Example 2. The cathode active material of Comparative Example 2 had a hybrid structure of hexagonal and monoclinic structures, whereas each of the cathode active materials of Examples 2-1 and 2-2 was confirmed to have a pure monoclinic structure.

Although specific experimental data were not presented herein, the lithium ion secondary batteries of Examples 4-1 and 4-2, which used the cathode active materials of Examples 2-1 and 2-2, respectively, showed an at least 7% increase in both initial output capacity and output capacity after 10 cycles compared to the lithium ion secondary battery of Comparative Example 4 using the cathode active material of Comparative Example 2.

What is claimed is:

1. A cathode active material of Formula 1:
LiₓMn(BO₃)_{y} (1)
wherein x is a real number satisfying 1≦x<2, y is a real number satisfying 1≦y<2, with the proviso that x and y are not simultaneously 1.

2. The cathode active material according to claim 1, wherein x is a real number satisfying 1<x<2 and y is a real number satisfying 1<y<2.

3. The cathode active material according to claim 2, wherein y is a real number satisfying 1.1≦y<2.

4. The cathode active material according to claim 2, wherein XRD analysis of the cathode active material shows that when the intensity of a first effective peak observed in the range of 2θ=33° to 36° is defined as 1, the intensity of a second effective peak observed in the range of 2θ=400 to 430 is from 0.1- to 0.5-fold and the intensity of a third effective peak observed in the range of 2θ=57° to 600 is from 0.0001- to 0.1-fold.

5. The cathode active material according to claim 2, wherein the proportion of monoclinic phase in the cathode active material is from 90% to 100%, based on the total proportion of monoclinic phase, hexagonal phase, and MnO phases.

6. The cathode active material according to claim 1, wherein x is 1 and y is a real number satisfying 1<y<2.

7. The cathode active material according to claim 6, wherein XRD analysis of the cathode active material shows that based on the intensity of a first effective peak observed in the range of 2θ=33° to 36°, each of the intensities of second and third effective peaks observed in the range of 2θ=35° to 400 is from 0.00001- to 0.1-fold.

8. The cathode active material according to claim 2, wherein the proportion of monoclinic phase in the cathode active material is from 90% to 100%, based on the total proportion of monoclinic and hexagonal phases.

9. A working electrode for a lithium ion battery comprising the cathode active material according to claim 1.

10. A lithium ion battery comprising the cathode active material according to claim 1.

11. A method for preparing a cathode active material of Formula 1:
LiₓMn(BO₃)_{y} (1)
wherein x is a real number satisfying 1≦x<2, y is a real number satisfying 1≦y<2, with the proviso that x and y are not simultaneously 1,
the method comprising (A) ball milling a mixture of a lithium precursor, a manganese precursor, a boron precursor, and a carbon compound, (B) annealing the ball-milled mixture, and (C) lowering the temperature of the annealed mixture.

12. The method according to claim 11, wherein the lithium precursor is selected from Li₂CO₃, LiOH.H₂O, LiNO₃, LiBO₂, and mixtures thereof, the manganese precursor is selected from MnC₂O₄.2H₂O, MnNO₃.(H₂O)₄, MnCO₃, MnO₂, and mixtures thereof, the boron precursor is selected from B₂O₃, B(OC₂H₅)₄, H₃BO₃, and mixtures thereof, and the carbon compound is selected from C₁₂H₂₂O₁₁, C₆H₁₀O₄, C₈H₈O₇, and mixtures thereof.

13. The method according to claim 11, wherein the carbon compound is used in an amount of 5 to 15% by weight, based on the total weight of the mixture.

14. The method according to claim 11, wherein, in step (A), the ball milling is performed by a dry process in which the precursors and the carbon compound are mixed and ground at a rate of 150 to 350 rpm using beads in an amount of 10 to 30 times the total weight of the mixture.

15. The method according to claim 11, wherein step (B) is carried out by heating the ball-milled mixture to 400 to 800° C. at a rate of 1 to 5° C./min and heating for 10 to 20 hours to maintain the temperature.

16. The method according to claim 15, wherein step (C) is carried out by lowering the temperature of the annealed mixture to room temperature at a rate of 1 to 5° C./min.

17. The method according to claim 16, wherein the cooling rate is from 0.8- to 1.2-fold compared to the heating rate.
